(19) United States
(12) Patent Application Publication
(10) Pub. No.: US 2022/0320922 A1
(43) Pub. Date: Oct. 6, 2022

(54) ROTATING ELECTRIC MACHINE PROVIDED WITH A COOLING CHAMBER

(71) Applicant: VALEO EQUIPEMENTS ELECTRIQUES MOTEUR, Creteil Cedex (FR)

(72) Inventors: Khadija EL BARAKA, Creteil (FR); Svetislav JUGOVIC, Creteil (FR)

(73) Assignee: VALEO EQUIPEMENTS ELECTRIQUES MOTEUR, Creteil Cedex (FR)

(21) Appl. No.: 17/615,770

(22) PCT Filed: Jun. 2, 2020
(86) PCT No.: PCT/EP2020/065229

§ 371 Date: Dec. 1, 2021

(30) Foreign Application Priority Data
Jun. 3, 2019 (FR) FR1905840

(51) Int. Cl. H02K 1/20; H02K 1/02; H02K 5/20; H02K 9/197

(52) U.S. Cl. CPC H02K 1/20; H02K 1/02; H02K 5/203; H02K 9/197

(57) ABSTRACT

A rotary electric machine, in particular for a motor vehicle, having a stator including a stator body and a winding, the stator body having a yoke and teeth coming from an internal periphery of the yoke. At least one bearing is provided with a recess intended to receive a means for guiding a shaft in rotation. A cooling chamber is disposed around the stator body and in which a cooling liquid circulates. At least an external portion of the yoke is made of a magnetic composite material, the cooling chamber being delimited at least in part on the one hand by an external periphery of the yoke of the stator body and on the other hand by an internal periphery of the bearing.

The present invention relates to a rotary electric machine provided with a cooling chamber. The invention is particularly advantageously, but not exclusively, applicable to rotary electric machines with which motor vehicles are equipped.

In a manner known per se, a rotary electric machine has a stator and a rotor that is secured to a shaft. The rotor may be secured to a driving and/or driven shaft and may belong to a rotary electric machine in the form of an alternator, an electric motor, or a reversible machine capable of operating in both modes.

The stator is mounted in a casing that is configured to rotate the shaft for example by means of rolling bearings. The rotor has a body formed by a stack of laminations held in the form of a pack by means of a suitable fastening system, such as rivets passing axially right through the body of the rotor. The rotor has poles that are formed for example by permanent magnets housed in cavities provided in the magnetic mass of the rotor, as is described for example in the document EP0803962. Alternatively, in what is known as a “salient-pole” architecture, the poles are formed by coils that are wound around arms of the rotor.

Furthermore, the stator has a body formed by a stack of thin laminations forming a ring, the inner face of which is provided with slots that are open toward the inside so as to receive phase windings. The phase windings are obtained for example from a continuous wire covered with enamel or pins that are welded to one another. These windings are polyphase windings that are connected in star or in delta, the outputs of which are connected to an electronic control module having a power inverter.

In order to cool the electric machine, the document WO2017216488 teaches the production of a cooling chamber disposed around the stator. A cooling liquid, such as water, is intended to circulate in the chamber so as to extract from the stator the heat energy that is generated by the flow of the currents in the winding.

The cooling chamber is delimited on the one hand by an external periphery of one of the bearings of the casing and on the other hand by an internal periphery of the other bearing of the casing. In order to establish close contact between the stator body and the cooling chamber, the stator body is interference fitted with an internal periphery of one of the bearings, and this constitutes a complex and expensive operation. In addition, such a configuration is bulky as a result of the radial superposition of the walls of the bearings for forming the cooling chamber.

The present invention aims to effectively remedy these drawbacks by proposing a rotary electric machine, in particular for a motor vehicle, having:

a stator comprising a stator body and a winding, said stator body having a yoke and teeth coming from an internal periphery of the yoke,

at least one bearing provided with a recess intended to receive a means for guiding a shaft in rotation, and

a cooling chamber disposed around the stator body and in which a cooling liquid circulates,

at least an external portion of the yoke being made of a magnetic composite material, the cooling chamber being delimited at least in part on the one hand by an external periphery of the yoke of the stator body and on the other hand by an internal periphery of the bearing.

The invention thus makes it possible to eliminate one of the bearings for forming the cooling chamber, and this makes the assembly more compact and has an economical nature. The fact that at least the external portion of the yoke is made of a magnetic composite material makes it possible to guarantee the sealing of the cooling chamber with respect to a stator body that is conventionally made entirely of laminations. In addition, the invention makes it possible to eliminate the interference-fitting step, such that the rotary electric machine is easier to produce.

According to one embodiment, the stator body is made entirely of a composite magnetic material.

According to one embodiment, the stator body has a first part formed by an internal portion of the yoke and the teeth and a second part formed by the external portion of the yoke made of a composite magnetic material. Such a configuration offers a good compromise in terms of magnetic performance.

According to one embodiment, the external portion of the yoke is overmolded around the internal portion of the yoke.

According to one embodiment, the external portion of the yoke is fastened to the internal portion of the yoke, in particular by fitting or adhesive bonding.

According to one embodiment, the external portion of the yoke has at least one groove intended to receive a seal.

According to one embodiment, the external portion of the yoke has a shoulder constituting an axial end wall of the cooling chamber.

According to one embodiment, the internal periphery of the bearing has a shoulder constituting an axial end wall of the cooling chamber.

According to one embodiment, the internal periphery of the bearing has a shoulder constituting an axial placement stop for an axial end of the stator body.

According to one embodiment, said rotary electric machine has a separating low wall between a cooling liquid inlet and a cooling liquid outlet.

According to one embodiment, a thickness of the external portion of the yoke is between 2 mm and 4 mm and is preferably of the order of 3 mm.

The invention will be better understood upon reading the following description and studying the accompanying figures. These figures are given solely by way of entirely non-limiting illustration of the invention.

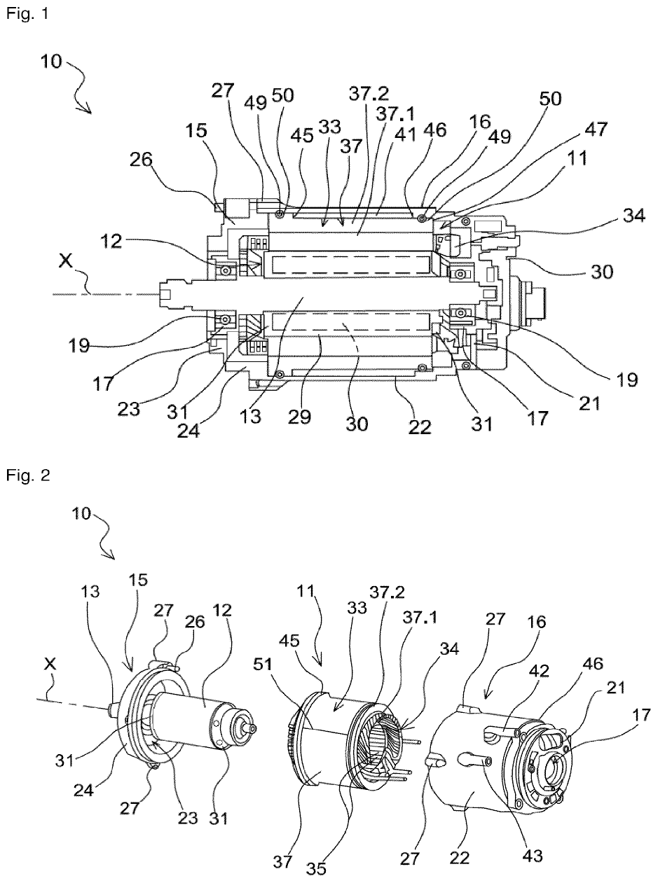

FIG. 1 is a view in longitudinal section of a first embodiment of a rotary electric machine according to the present invention;

FIG. 2 is an exploded perspective view of the rotary electric machine in FIG. 1;

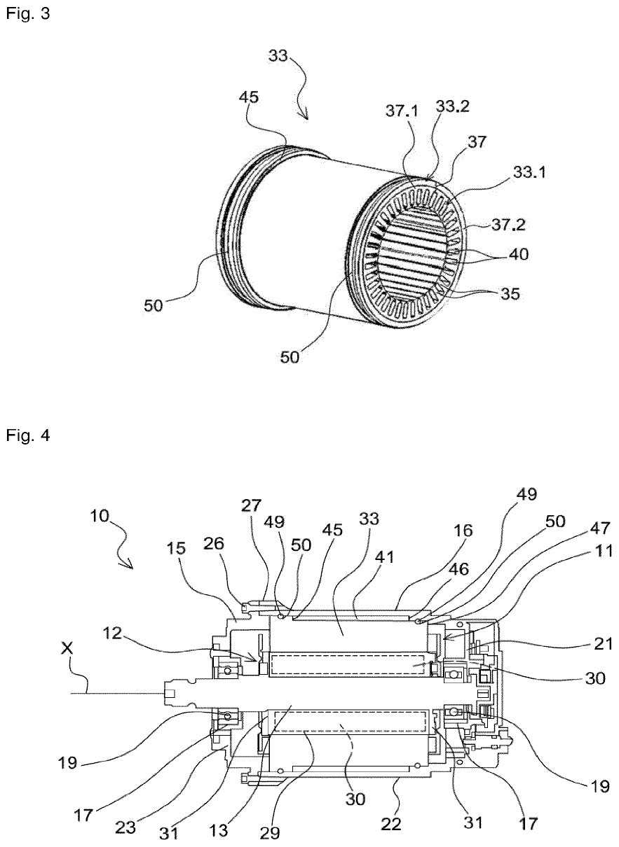

FIG. 3 is a perspective view of the stator of the rotary electric machine in FIG. 1;

FIG. 4 is a view in longitudinal section of a second embodiment of a rotary electric machine according to the present invention;

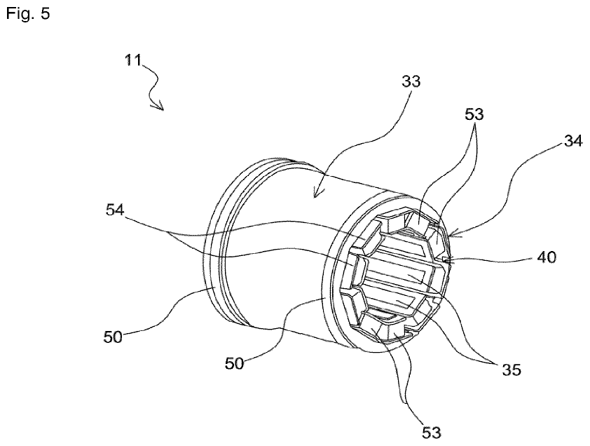

FIG. 5 is a perspective view of the stator of the rotary electric machine in FIG. 4.

Identical, similar, or analogous elements retain the same references from one figure to another.

FIG. 1 shows a rotary electric machine 10 having a polyphase stator 11 surrounding a rotor 12 mounted on a shaft 13 of axis X corresponding to the axis of the electric machine 10. The stator 11 surrounds the rotor 12 with an air gap being present between the internal periphery of the stator 11 and the external periphery of the rotor 12. The electric machine 10 also has a front bearing 15 and a rear bearing 16 each provided with a recess 17 intended to receive a means 19 for guiding the shaft 13 in rotation, such as a ball bearing.

The front bearing 15 is situated on the side of the output of the shaft 13, which output is intended to cooperate with an external element of the machine (belt system, gear mechanism, or the like), while the rear bearing 16 is situated on the opposite side with respect to the output of the shaft 13.

As may be seen in FIG. 2, the rear bearing 16 has a portion 21 that is oriented transversely with respect to the axis X comprising centrally the recess 17 for a rolling bearing 19 and from which an annular portion 22 of axial orientation that has an axial length at least equal to that of the stator 11 departs.

The front bearing 15 has a transverse portion 23 comprising centrally a recess 17 for a rolling bearing 19 and from which an annular portion 24 that is axially shorter than the annular portion 22 of the rear bearing 16 departs. The front bearing 15 forms a cover intended to close the open end of the rear bearing 16. To this end, fastening members 26, such as screws or rivets, cooperate with projecting lugs 27 realized on the external periphery of the front bearing 15 and of the rear bearing 16. As a variant, the configurations of the front bearing 15 and of the rear bearing 16 may of course be reversed, i.e. the rear bearing 16 may act as a cover for the front bearing 15.

The rotor 12 has, in a manner known per se, a body 29 in the form of a pack of laminations. Permanent magnets 30 are installed in cavities in the body 29, as shown in FIGS. 1 and 4. The permanent magnets 30 may be made of rare earths or ferrite depending on the applications and the desired power of the electric machine 10. Furthermore, the rotor 12 has two flanges 31 each pressed against an axial end face of the rotor 12. These flanges 31 ensure axial retention of the magnets 30 and serve, if appropriate, to balance the rotor 12.

Furthermore, the stator 11 has a body 33 and a winding 34. As is illustrated by FIG. 3, the stator body 33 is provided with teeth 35 coming from an internal periphery of an annular yoke 37 that is oriented axially with respect to the axis X. The teeth 35 and the yoke 37 have a magnetic function, insofar as the magnetic flux of the electric machine passes through these elements so as to ensure operation of the electric machine.

The teeth 35 delimit, in pairs, slots 40 for mounting the winding 34 of the stator 11. Thus, two successive notches 40 are separated by a tooth 35. The slots 40 open axially into the axial end faces and radially towards the inside of the stator body 33.

According to this embodiment, the stator body 33 is produced in two parts, namely a first part 33.1 formed by an internal portion 37.1 of the yoke 37 from which the teeth 35 depart and a second part 33.2, which is independent of the first part 33.1, formed by an external portion 37.2 of the yoke 37.

The first part 33.1, namely the assembly “internal portion 37.1 of the yoke 37 and teeth 35”, is formed by a pack of laminations produced by a stack of laminations held in the form of a pack by means of a suitable fastening system, such as rivets.

The second part 33.2, namely the external portion 37.2 of the yoke 37, is made of a composite magnetic material, or SMC (“Soft Magnetic Composite”) material. This material contains powder of ferromagnetic material, such as steel powder, of which the particles are bonded with an insulating material, for example a polymer material that is resistant to high temperatures.

The external portion 37.2 of the yoke 37 is preferably overmolded around the internal portion 37.1 of the yoke 37. As a variant, the external portion 37.2 of the yoke 37 is fastened to the internal portion 37.1 of the yoke 37, in particular by fitting or adhesive bonding.

In its active part, i.e. the part in which a magnetic flux that is useful for the operation of the electric machine 10 circulates, the external portion 37.2 of the yoke 37 has a thickness of between 2 mm and 4 mm and preferably of the order of 3 mm. The internal portion 37.1 of the yoke 37 has a thickness of between 1.5 mm and 3 mm and preferably of the order of 2 mm.

The winding 34 shown in FIGS. 1 and 2 has a set of phase windings passing through the slots 40 and forming visible portions that protrude on either side of the stator body 33. In the example shown, the winding 34 is made from conductive elements in the form of pins, which are connected to one another for example by welding. These windings are for example three-phase or dual three-phase windings connected in star or in delta.

In order to cool the electric machine 10, a cooling chamber 41 is disposed around the stator body 33, as shown in FIG. 1. The cooling chamber 41 may advantageously have an annular shape. The cooling chamber 41 is provided with an inlet 42 and an outlet 43 for cooling liquid (cf. FIG. 2) so as to allow circulation of the cooling liquid inside the cooling chamber 41 around the stator body 33.

The cooling chamber 41 is delimited at least in part on the one hand by an external periphery of the yoke 37 of the stator body 33 and on the other hand by an internal periphery of one of the bearings. In this case, the cooling chamber 41 is delimited at least in part on the one hand by an external periphery of the external portion 37.2 of the yoke 37 and on the other hand by an internal periphery of the rear bearing 16.

Thus, since the cooling liquid, such as water or oil or any other liquid with high heat transfer capability suitable for the application, is in direct contact with the stator body 33, the extraction of the heat energy generated by the current circulating in the winding 34 is optimal.

The external portion 37.2 of the yoke 37 has a shoulder 45 that is defined by a difference in external diameter and constitutes an axial end wall of the cooling chamber 41.

The rear bearing 16 has an internal periphery with a stepped diameter having a shoulder 46 constituting the other axial end wall of the cooling chamber 41. The internal periphery of the rear bearing 16 also has a shoulder 47 constituting an axial placement stop for an axial end of the stator body 33.

The cooling chamber 41 is sealed by seals 49, in particular of the O-ring type, which are each disposed in a corresponding groove 50 provided in the external portion 37.2 of the yoke 37. As a variant, the grooves 50 for receiving the seals 49 may be provided in the internal periphery of the rear bearing 16.

Preferably, a low wall 51 makes it possible to separate the cooling liquid inlet 42 and the cooling liquid outlet 43 in order to promote renewal of the cooling liquid in the chamber 41.

As a variant, in the embodiment in FIGS. 4 and 5, the stator body 33 is made entirely of a composite magnetic material. The stator 11 may have a winding 34 made from continuous wires or pins as above, or from individual coils 53 wound around the teeth 35 of the stator 11 by way of a coil insulator 54, as shown in FIG. 5.

Of course, the above description has been given solely by way of example and does not limit the scope of the invention; replacing the various elements with any other equivalents would not constitute a departure from said scope.

Furthermore, the various features, variants and/or embodiments of the present invention may be combined with one another in various combinations, as long as they are not mutually incompatible or mutually exclusive.

1. A rotary electric machine, in particular for a motor vehicle, having:
a stator comprising a stator body and a winding, said stator body having a yoke and teeth coming from an internal periphery of the yoke,
at least one bearing provided with a recess intended to receive a means for guiding a shaft in rotation, and
a cooling chamber disposed around the stator body and in which a cooling liquid circulates,
wherein at least an external portion of the yoke is made of a magnetic composite material and in that the cooling chamber is delimited at least in part on the one hand by an external periphery of the yoke of the stator body and on the other hand by an internal periphery of the bearing.

2. The rotary electric machine as claimed in claim 1, wherein the stator body is made entirely of a composite magnetic material.

3. The rotary electric machine as claimed in claim 1, wherein the stator body has a first part formed by an internal portion of the yoke and the teeth and a second part formed by the external portion of the yoke made of a composite magnetic material.

4. The rotary electric machine as claimed in claim 3, wherein the external portion of the yoke is overmolded around the internal portion of the yoke.

5. The rotary electric machine as claimed in claim 3, wherein the external portion of the yoke is fastened to the internal portion of the yoke, in particular by fitting or adhesive bonding.

6. The rotary electric machine as claimed in claim 1, wherein the external portion of the yoke has at least one groove intended to receive a seal.

7. The rotary electric machine as claimed in claim 1, wherein the external portion of the yoke has a shoulder constituting an axial end wall of the cooling chamber.

8. The rotary electric machine as claimed in claim 1, wherein the internal periphery of the bearing has a shoulder constituting an axial end wall of the cooling chamber.

9. The rotary electric machine as claimed in claim 1, wherein the internal periphery of the bearing has a shoulder constituting an axial placement stop for an axial end of the stator body.

10. The rotary electric machine as claimed in claim 1, wherein it has a separating low wall between a cooling liquid inlet and a cooling liquid outlet.

11. The rotary electric machine as claimed in claim 1, wherein a thickness of the external portion of the yoke is between 2 mm and 4 mm and is preferably of the order of 3 mm.

12. The rotary electric machine as claimed in claim 2, wherein the external portion of the yoke has at least one groove intended to receive a seal.

13. The rotary electric machine as claimed in claim 2, wherein the external portion of the yoke has a shoulder constituting an axial end wall of the cooling chamber.

14. The rotary electric machine as claimed in claim 2, wherein the internal periphery of the bearing has a shoulder constituting an axial end wall of the cooling chamber.

15. The rotary electric machine as claimed in claim 2, wherein the internal periphery of the bearing has a shoulder constituting an axial placement stop for an axial end of the stator body.

16. The rotary electric machine as claimed in claim 2, wherein it has a separating low wall between a cooling liquid inlet and a cooling liquid outlet.

17. The rotary electric machine as claimed in claim 2, wherein a thickness of the external portion of the yoke is between 2 mm and 4 mm and is preferably of the order of 3 mm.

18. The rotary electric machine as claimed in claim 3, wherein the external portion of the yoke has at least one groove intended to receive a seal.

19. The rotary electric machine as claimed in claim 3, wherein the external portion of the yoke has a shoulder constituting an axial end wall of the cooling chamber.

20. The rotary electric machine as claimed in claim 3, wherein the internal periphery of the bearing has a shoulder constituting an axial end wall of the cooling chamber.
